(19) United States
(12) Patent Application Publication
(10) Pub. No.: US 2013/0333577 A1
(43) Pub. Date: Dec. 19, 2013

(54) GRILLING APPARATUS

(71) Applicants: Eric Pitner, Bartlesville, OK (US); David Walker, Bartlesville, OK (US); Craig Stark, Chelsea, OK (US); Deon Smith, Bartlesville, OK (US)

(72) Inventors: Eric Pitner, Bartlesville, OK (US); David Walker, Bartlesville, OK (US); Craig Stark, Chelsea, OK (US); Deon Smith, Bartlesville, OK (US)

(73) Assignee: THE GRILL MEN, Bartlesville, OK (US)

(21) Appl. No.: 13/918,568

(22) Filed: Jun. 14, 2013

Related U.S. Application Data
(60) Provisional application No. 61/660,456, filed on Jun. 15, 2012.

(51) Int. Cl. A47J 37/04

(52) U.S. Cl. CPC A47J 37/041
USPC 99/421 A; 99/443 R

(57) ABSTRACT

Cooking apparatuses are disclosed for evenly cooking a variety of foods over a grilling surface with heat being radiated and/or reflected from a plurality of surfaces. In particular, the cooking apparatus is suitable for grilling a variety of foods such as meats, poultry and vegetables in a vertical rack to more evenly cook such foods.

### FIELD

The present invention relates to cooking apparatuses. In particular, the invention relates to grilling apparatuses for grilling a variety of foods such as meats, poultry and vegetables in a vertical rack to more evenly cook such foods.

### BACKGROUND

In the typical grilling of foods, the traditional method has been to put meats, poultry and vegetables on a grill surface, typically over open flame or hot coals. However, it is often difficult to cook such food uniformly without some burning or charring. The food must be constantly watched and rotated on the grill. Unfortunately, even with careful attention, it is easy to cook the food in an uneven manner.

Additionally, if a grill is not lubricated before cooking, food often sticks to the grill during the grilling process. This can cause loss of moisture content when unsticking the food and cause dryness. Even with the use of skewers inserted through such food, sticking remains a problem.

Furthermore, the sticking of food to a grill, when the food is placed on a hot grill with a skewer can result in particles of food remaining attached to the grill after the meats, poultry or vegetables are removed. This results in residue that is difficult to clean without the use of metal brushes.

One option to prevent sticking is the use of foil between the food and the grilling surface. However, foil can often prevent flavor from permeating the food, which is desirable in over the flame cooking.

In an attempt to achieve the flavor associated with open flame grilling without the problems associated with food sticking to a grill, one could hold meat, poultry or vegetables over the flame with a skewer. However this method is involved and still results in uneven cooking.

As an additional consideration, a typical non-commercial grill surface has a finite area in which food is cooked. One option to overcome this obstacle is to stack food. However this can compound the uneven cooking problem by having food even further away from the flame.

It would therefore be desirable to produce a grilling apparatus which prevented food from sticking to the grill, allowed the full flavor from open flame cooking to permeate the food, and provided even cooking of the food.

### SUMMARY

Certain embodiments of the invention pertain to a device for distributing heat in more than one direction to cook food products, the device comprising: a base frame positioned on a grilling surface, the base frame having a perimeter, the area within the perimeter substantially open to allow heat to travel in a distal direction; two or more vertical supports with proximal ends connected to the base frame and distal ends connected to a top plate, each vertical support having a vertical support axis; a plurality of skewer supports attached to the vertical supports and defining a first plane, the first plane being a defined distance from the base frame; a top plate with a proximal side connected to the vertical supports, the top plate being able to reflect heat emitted from the grilling surface or radiate heat; and a plurality of skewers for holding food within the device, each skewer being positioned and held in place by a skewer support of one vertical support and a skewer support of another vertical support.

In certain embodiments, wherein the skewer supports are contemplated, the device further comprises a plurality of skewer supports defining a second plane, the second plane being a greater distance from the base frame than the defined distance.

Still further in discussing the invention, the top plate reflects heat from the grilling surface. In the alternative or additionally, the top plate radiates heat. Further, in certain embodiments when contemplating the top plate, the top plate comprises of multiple heat plates.

In certain embodiments wherein in multiple heat plates are contemplated, each heat plate is in physical connection with each other heat plate at a juncture. Often the juncture is at a distal most position on the device from the grilling surface. Alternatively the two or more heat plates are not in physical connection with each other at a juncture, the juncture having a distance between the two or more heat plates. In such embodiments, the juncture is capable of being increased or decreased.

In additional embodiments of the invention, wherein the vertical supports are contemplated, each vertical support comprises a lower vertical support and an upper vertical support, the lower vertical support having a hollow bore adapted to receive the upper vertical support. In such embodiments the lower vertical support comprises a threaded bore perpendicular to the vertical support axis and adapted to receive a threaded screw or bolt. In such embodiments, the distance between the top plate and the grilling surface is capable of being increased or decreased.

Further embodiments of the invention relate to a method of directing heat from the base frame of the device to the food. One such method comprises a base frame with a plurality or rotatable slats, wherein each rotatable slat is connected to the base frame at two points on opposite sides of the base frame. Still further, the rotatable slats are capable of being slanted to direct heat from the grilling surface at an angle or closed to deflect some heat from the grilling surface.

Other embodiments of the present invention pertain to a device for distributing heat in more than one direction to cook food products, the device comprising: an oval or circular base frame positioned on a grilling surface, the base frame having a perimeter, the area within the perimeter substantially open to allow heat to travel in a distal direction, the area at the center of the perimeter having a central vertical support; two or more vertical skewer supports with proximal ends connected to the base frame and rising distally from the base frame; a plurality of skewer supports attached to the vertical skewer supports and attached to the central vertical support, the skewer supports defining a first plane, the first plane being a defined distance from the base frame; an oval or circular top plate with a proximal side connected to the central vertical support, the top plate being able to reflect heat emitted from the grilling surface or radiate heat; and a plurality of skewers for holding food within the device, each skewer being positioned and held in place by a skewer support of one vertical skewer support and a skewer support of the central vertical support.

In this aforementioned embodiment, the device further comprises a single top plate shaft, extending proximally from the top plate and adapted to be received by the central vertical support.

Still further, the central vertical support of the device further comprises a threaded bore adapted to receive a central threaded screw, the tightening of the screw preventing sliding of the top plate shaft within the central vertical support. In such embodiments, the top plate is adjustable in a proximal or distal direction relative to the oval or circular base frame.

### BRIEF DESCRIPTION OF THE DRAWINGS

FIG. 1 is an illustration of one embodiment of the grilling apparatus with adjustable distance between the top plate and the base frame.

FIG. 2 is an illustration of one embodiment of the grilling apparatus with an oval or circular shape.

FIG. 3A is an illustration of one embodiment of the grilling apparatus with rotatable slats. FIG. 3B illustrates the slats in an open configuration and FIG. 3C illustrates the slats in a closed configuration.

FIG. 4 is an illustration of one embodiment of the invention with movable heat plates.

FIG. 5 is an illustration of a an embodiment of the invention with an elevated grilling surface.

### LIST OF REFERENCE NUMERALS

5 grilling device
10 grilling surface
15 base frame
20 vertical supports
25 skewer supports
30 top plate shafts
35 heat plate rack
40 screws
45 threaded bores
50 heat plates
55 top plate
205 oval or circular base frame
210 vertical skewer supports
215 single vertical support
220 single top plate shaft
225 circular or oval top plate
230 central screw
235 central threaded bore
310 rotatable slats
405 vertical skewer supports
410 base frame bores
415 juncture
420 heat plate screws
420 oblong slots
430 elevated grilling surface
440 elevated grilling surface frame
450 cooking plane
460 skewers

### DETAILED DESCRIPTION

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings making apparent to those skilled in the art how the several forms of the invention are embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3rd Edition.

Distal is defined as away from the grilling surface.

Proximal is defined as toward the grilling surface.

Stainless steel is defined as any iron alloy generally resistant to oxidation.

Radiate is be defined as an emission of energy from a particular object or objects.

Convection is defined as the reflection of energy from one direction to another direction.

Substantially parallel is defined as two surfaces which are parallel to one another to two surfaces which are less than a 45 degree angle from one another.

Certain embodiments of the invention relate to a rack to hold one or more skewers in a plane which is substantially parallel to a grilling surface having a defined plane. Still further, certain embodiments of the invention relate to a rack having multiple skewers in a single plane which is substantially parallel to the aforementioned plane of the grilling surface. In such instances, a single plane is defined as having the skewer or skewers possessing a generally uniform distance from the grilling surface.

Still further, other embodiments of the invention relate to a rack having a plurality of skewers in a plurality planes which are parallel to the aforementioned grill surface. In such instances, multiple planes are defined as having the skewer or skewers in a first plane possessing a generally uniform first distance from the grilling surface and the skewers in another plane possessing a generally uniform subsequent distance from the grilling surface wherein the difference between the first distance and the grilling surface is different than the distance between the subsequent distance and the grilling surface. In some embodiments wherein a plurality of planes is contemplate there are two different planes, although it is conceived that in certain embodiments, there are 3, 4, 5, 6, 7, 8, 9 10 or more planes.

Still further, certain embodiments of the invention pertain to a convection apparatus or heat radiating apparatus which is distal to the distal most plane. In such embodiments, energy, in the form of heat is radiated from a top plate positioned distal to the distal most plane of skewers.

The top plate, in certain embodiments, comprises multiple heat plates in certain embodiments. In other embodiments, the heat plate is a single heat plate. In embodiments wherein the top plate comprises multiple heat plates, each part is either parallel to the grilling surface or diagonal to the grilling surface. In specific embodiments, wherein each part is diagonal to the grilling surface, the parts, in certain embodiments, meet at a juncture. The juncture is on the opposite edge of the heat plates from the heat plate outer edge. The juncture is distally at a greater distance from the grilling surface than the heat plate outer edges. Conversely, the juncture is at a closer distance proximally from the grilling surface than the heat plate outer edges. In certain embodiments, the heat plates are in physical connection at the juncture, in other embodiments, the heat plates are separated from each other by a distance at the juncture. In embodiments wherein the heat plates are separated by a distance, the distance varies and can be 0.5 cm, 1 cm, 1.5 cm, 2 cm, 3 cm, 4 cm, 5 cm or more or some distance in between the aforementioned distances. In a specific embodiment, there are two heat plates with a physical connection at the junction with the junction being a greater distance distally from the grilling surface than the outer edges of the heat plates so as to form an upside down “V” shape.

The heat plates in certain embodiments are placed on a heat plate rack such that they are positioned at the desired angle and with the desired distance at the juncture. The heat plate rack in such instances is made of a metal, a ceramic or other element or composition capable of withstanding cooking temperatures without burning or deforming. In certain embodiments, the heat plates are simply placed upon the heat rack and moved manually to the desired juncture distance. In other embodiments, the plates are affixed to the plate rack by welding, casting, forging, pinning, or bolting the plates to the rack. In still further embodiments, the juncture distance or the angle at which the heat plates are positioned relative to the grilling surface can be modified through the use of gears and the like to be operated by the user.

With respect to cooking temperatures, the cooking temperatures could be any temperature typically used in the home or professional cooking of food. For example, the cooking temperature could be 50° C., 100° C., 200° C., 300° C., 400° C., 500° C., 600° C., 700° C., 800° C., 900° C. or 1000° C. or some interval therein as long as cooking of food takes place.

In other embodiments, wherein multiple heat plates are contemplated, there are a plurality of junctures. For example, in certain embodiments, there are multiple triangular shaped heat plates which form a functionally concave or functionally convex triangle, square, pentagon, hexagon, heptagon, octagon, nonagon, decagon or greater. In such instances four heat plates would form a square; five heat plates form a pentagon and so forth.

In different embodiments, the top plate is a single plate with one or more outside edges. A plate which is oval or circular can be considered to have one outside edge, whereas a plate which is in the form of an upside down “V” can be thought of as having two outside edges. In such instances, the top plate is flat and parallel or diagonal to the grilling surface. In other instances the top plate is concave or convex and with a single outside edge.

In embodiments of the invention concerning a top plate or heat plates or both, the plates comprise materials designed to reflect heat to the food which is proximal to the plate. In other instances, the materials of the top plate or heat plates are designed to absorb heat and radiate the heat onto the food placed proximally to the plate. The top plate or heat plate is generally made of stainless steel, aluminum, copper, brass, nickel, an iron alloy, a glass, quartz, a ceramic and the like. When heat reflection is contemplated, the material, in certain embodiments, is coated with a heat reflective paint or the material is itself heat reflective. When heat radiation is contemplated, the material, in certain embodiments, has a high specific heat capacity to store and radiate heat. Specific heat capacity is defined as the ability of a given substance to retain heat. For example, steel retains heat longer than aluminum when exposed a certain temperature for a certain length of time.

Further embodiments of the invention concern the base frame. The base frame is designed to rest upon the grilling surface. The frame, in certain embodiments, is similar or exactly the shape of the top plate. For instance, if the top plate is square or a square pyramidal structure, the base frame in this embodiment also has a square perimeter. Likewise, if the top plate is circular or oval, the base frame, in certain embodiments has a circular or oval shape. The base frame is made of any durable material that is capable of withstanding cooking temperatures without burning or deforming. Like the plate rack, the base frame should be able to withstand temperatures as needed for correctly cooking foods. The base frame is made of any durable material such as stainless steel, ceramic and the like.

All materials of the present invention are made out of any material capable of not burning or deforming during cooking temperatures. Among those contemplated are metals such as steel, high temperature plastics, ceramics, high temperature glass, quartz and the like.

Still further when discussing the base frame, the base frame has an open area around the perimeter. The open area is designed to allow heat from the grilling surface to move in a distal direction to the plane or plane of skewers holding food.

The open area of the base frame, in certain embodiments, has slots or holes within a base frame plate. Immediately distal to and in connection with the base frame plate, in certain embodiments, is a distal frame plate with slots or holes of the same shape as those of the base frame plate. In this embodiment, the distal frame plate is movable in a horizontal direction such that in one position, the holes or slots of the base plate are in alignment with the holes or slots of the distal base plate to allow heat to travel in a distal direction toward the food Likewise, the distal base plate is moved such that the holes or slots are only partially aligned or not aligned with the holes or slots of the base plate to partially or completely inhibit the travel of heat from the grilling surface to the food. Still further in certain embodiments, the base plate has rotatable slats which run the length of one side of the base plate and are connected to the base plate on opposite sides. The rotatable slates are therefore similar in function and design to an adjustable air conditioning vent found in residential homes. The slats can be opened or closed or partially opened or closed by the user to allow heat transfer and heat direction. The rotatable slats or both the base plate and the distal base plate are made of any material which does not burn or deform during the cooking process when exposed to grilling temperatures. In specific embodiments, the rotatable slats or the base plate and distal base plate comprise stainless steel or a ceramic.

Other embodiments of the invention contemplate the connection between the top plate and the base frame. In certain embodiments, vertical supports are attached to the base frame in a direction which is perpendicular to the grilling surface and wherein the vertical supports rise upward in a distal direction from the base frame. In such embodiments, the vertical supports are welded, cast, forged, or bolted to the base frame Like all materials used herein the vertical supports are made of any material which does not burn or deform during the cooking process and which is rigid.

In certain embodiments, the vertical supports connect directly to the top plate or the plate frame.

In other embodiments, the vertical supports are in an axis with and connect with top plate shafts. In such embodiments, top plate shafts are connected directly to the top plate or the plate frame and are positioned in a manner which is perpendicular to the grilling surface. The top plate shafts are positioned proximally from the top plate or the plate frame. The top plate shafts connect to the vertical supports. In certain embodiments, the vertical supports possess a hollow bore and are adapted to receive the top plate shafts. In other embodiments, the top plate shafts possess a hollow bore adapted to receive the vertical supports. In embodiments wherein top plate shafts and vertical supports are contemplated, the top plate can be moved in a proximal or distal direction relative to the base frame and grilling surface. Upon positioning the top plate a desired distance from the grilling surface, the vertical supports and the top plate shafts can be locked into position. In such cases, the top plate shafts or the vertical supports which possess the hollow bore, depending on configuration, also possesses a threaded bore which is parallel to the grilling surface and into which a screw or bolt can be inserted to tighten the top plate shafts to the vertical supports or vice versa. In alternative embodiments, the item with the hollow bore has a series of bores in a parallel direction to the grilling surface and the item without the hollow bore has a parallel bore as well. In such embodiments, a pin, bolt or rod can be placed laterally or parallel to the grilling surface to secure the top plate at a desired distance from the base frame.

It is also conceived that in some embodiments, there will only be one vertical support and one top plate shaft.

Further embodiments of the invention pertain to skewers and planes of skewers. In certain embodiments, the skewers rest on skewer holders. The skewer holders are attached to the vertical supports when at least two vertical supports are used. Alternatively, the skewers are attached to vertical skewer holder supports if the vertical supports are not used. Preferably, if vertical skewer holder supports are used, they are connected to the base frame in the same manner as vertical supports. In alternative embodiments, the base frame has base frame bores which are perpendicular to the grilling surface into which vertical supports or vertical skewer supports are placed.

Typically, the skewer supports are attached such that they are perpendicular to the vertical supports or vertical skewer supports. On other configurations, the skewer supports are at an angle wherein the point of attachment to the vertical supports or the vertical skewer supports is proximal to the end of the skewer supports. In other embodiments, the skewer supports are in a “U” shape and attached to the vertical supports or the vertical skewer supports. Other shapes of skewer supports are contemplated which do not depart from the spirit of the invention.

In certain embodiments, skewer supports are incrementally spaced on the vertical supports or vertical skewer supports such that the distance between the grilling surface or the base frame and the first plane of skewers is the same as the distance between the first and second plane of skewers and so forth.

In certain embodiments, vertical supports or vertical skewer supports are placed along opposite sides of the grilling device such that the majority of the skewer length is within the inside of the base frame perimeter. As an example, when the base frame is a square, the vertical supports holding skewer supports or the vertical skewer supports holding skewer supports would be placed on opposite sides of the square rather than on adjacent sides of the square.

In certain embodiments wherein the base frame is round or oval in shape, there is a vertical support or a vertical skewer support in the middle of the frame. This central vertical support or vertical skewer support is connected to the base frame via horizontal support rods which run the diameter of the circle, or in the case of the oval, the horizontal support rods connect one portion of the oval to another portion of the oval with an intersection in the middle of the oval. In such embodiments, the perimeter of the oval or circular base frame has vertical skewer supports or vertical supports spaced incrementally around the perimeter such that the end of the skewer which the user holds is close to the such supports and the opposite end of the skewer is resting on skewer supports of the central vertical support or central vertical skewer support.

Like other items of the invention, the vertical skewer supports, when used, and the skewer supports are made of any rigid durable material which is resistant to burning and deformation from heat needed for cooking food.

In certain embodiments of the invention, in lieu of or in addition to skewers, an elevated grilling surface, having a frame and a grill, is present which is substantially perpendicular to the frame base. The elevated grilling surface is supported by skewer supports via pegs extending perpendicularly from the frame of the elevated grilling surface. Alternatively, the elevated grilling surface is supported by skewer supports via skewers immediately proximal to the elevated grilling surface frame. These pegs or skewers are supported by resting upon skewer supports. Optimally, this embodiment is used in conjunction with a frame base which is rectangular or square. Optimally, the elevated grilling surface frame is the same perimeter or a slightly smaller perimeter than the frame base. In particular embodiments, the perimeter of the elevated grilling surface frame is the same dimension but slightly smaller than the frame base. In such embodiments, the elevated grilling surface frame can be placed within the frame base when not in use. In more specific embodiments, the frame base is able to retain the elevated grilling surface frame from movement in a proximal direction should the entire cooking apparatus be picked up or moved in a distal direction from the heat source. In such embodiments, the proximal side of the base frame has an inward facing lip to meet with the proximal side of the elevated grilling surface frame and prevent any further movement in a proximal direction.

In certain embodiments, the elevated grilling surface comprises wires extending from one side of the elevated grilling surface frame to another side, diagonally, longitudinally, latitudinally or some combination thereof. In such embodiments, food is placed on the wires for cooking. In other embodiments, the food is placed on a cooking plane supported by the elevated grilling surface frame. In certain embodiments the cooking plane is solid. In other embodiments, the cooking plane is perforated with diamond shaped holes, oval shaped holes, square shaped holes, triangular shaped holes, round holes and the like. In the embodiments wherein there is an elevated grilling surface, the elevated grilling surface is able to move in a proximal or distal direction by moving the grilling surface so that it is supported by skewer supports which are closer to the base frame or further away from the base frame.

It should be appreciated by those of skill in the art that changes can be made in the specific embodiments which are disclosed and still obtain a like or similar result without departing from the spirit or scope of the invention.

It should also be appreciated that the embodiments herein are not limited in size. For example, the device is proportioned to cook food such as chicken breasts and bell peppers. Alternatively, the device is proportioned to cook food such as whole chickens or brisket. Still further, the device is proportioned to cook food such as a whole pig, sheep and the like.

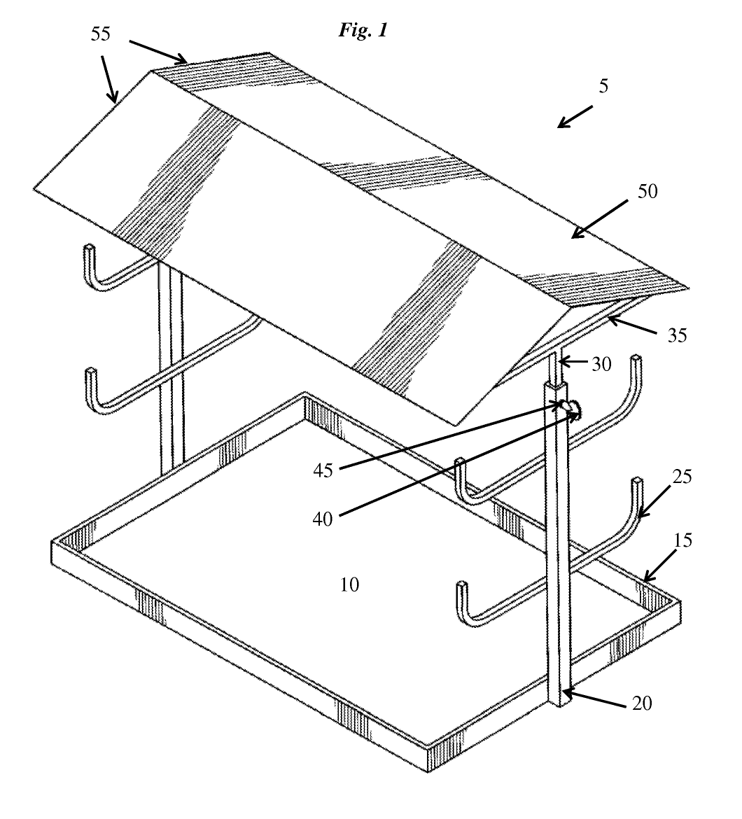

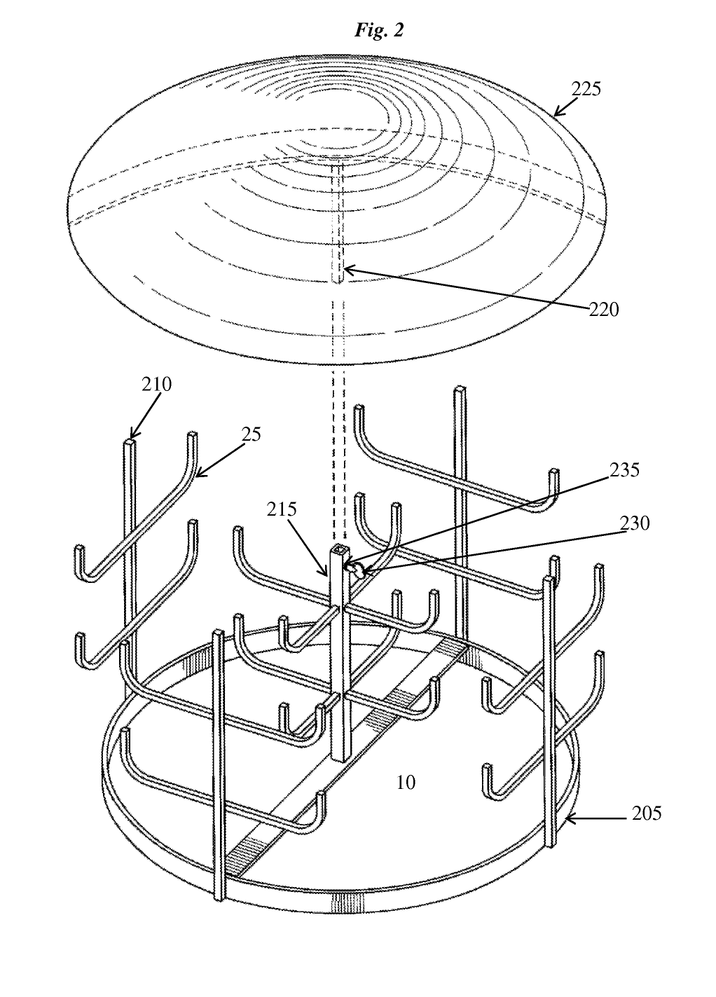

Now referring to FIG. 1 a grilling device 5 is resting on a grilling surface 10. The grilling device 5 comprises, at the proximal most end, a base frame 15. Rising distally from the base frame 15 are vertical supports 20, to which skewer supports 25 are attached. At the distal end of the vertical supports are top plate shafts 30 which extend proximally from the heat plate rack 35. The top plate shafts 30 fit within the vertical supports 20 and are secured from unwanted sliding within the vertical supports 20 by screws 40, which are threaded into threaded bores 45 along the sides of the vertical supports 20. The top plate shafts are physically connected to the heat plate rack 35. Heat plates 50, which comprise the top plate 55 are attached to the heat plate rack 35. Skewers rest within the skewer supports 25 and hold food.

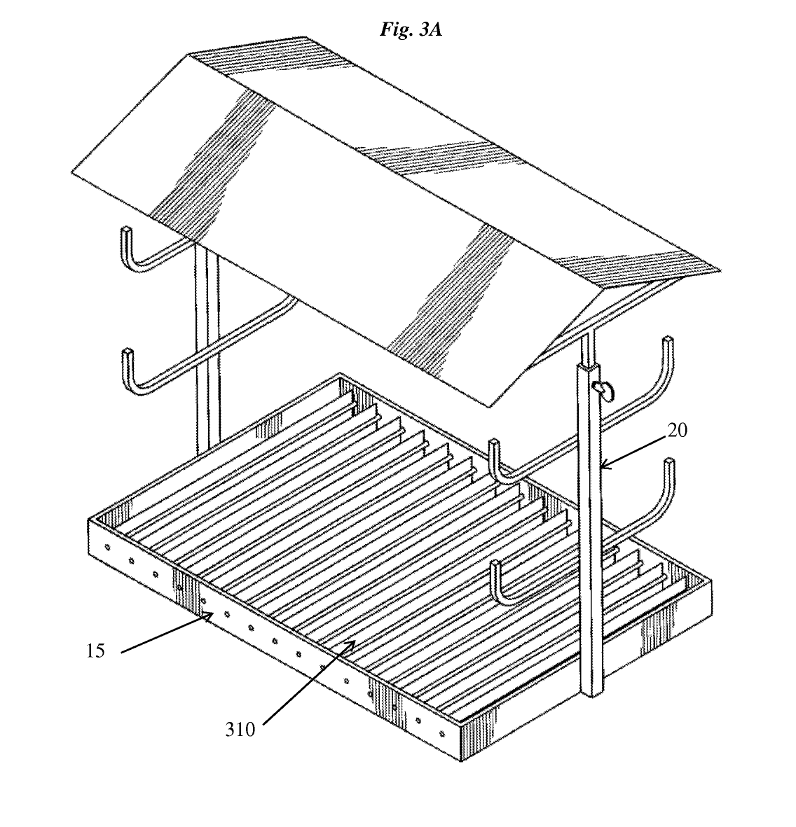

Referring to FIG. 2, an oval or circular base frame 205 rests upon a grilling surface 10. Spaced around the circular base frame 205 are vertical skewer supports 210 to which skewer supports 25 are affixed. Rising out of the center of the oval or circular base frame is a single vertical support 215 with skewer supports 25 attached thereto. Distal to the single vertical support is a single top plate shaft 220 connected directly to a circular or oval top plate 225. Skewers are positioned from the skewer supports 25 on the vertical skewer supports 210 to the skewer supports on the vertical support. Also seen is a central screw 230 which is threaded in to the central threaded bore 235.

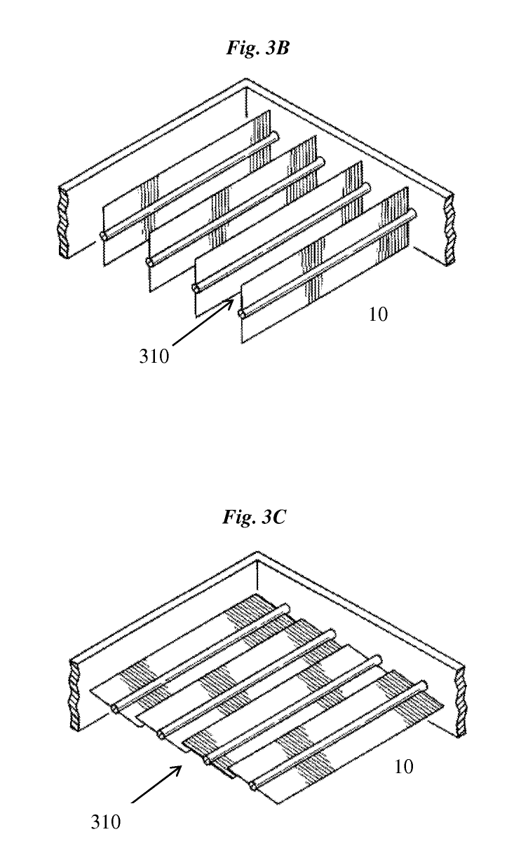

FIG. 3A is a view of one embodiment of the base frame 15 resting upon the grilling surface 10 as viewed from above the grilling surface 10. As shown in FIG. 3, the base frame 15 is a square or rectangular shape and comprises rotatable slats 310 which extend from one side of the base frame 15 to the opposite side of the base frame 15. As also seen from the base frame 15 are vertical supports 20. As can be seen in FIG. 3B, the rotatable slats 310 can be open to let in heat from the grilling surface 10. Alternatively, as can be seen in FIG. 3C, the rotatable slats 310 can be closed or partially closed to deflect some heat from the grilling surface.

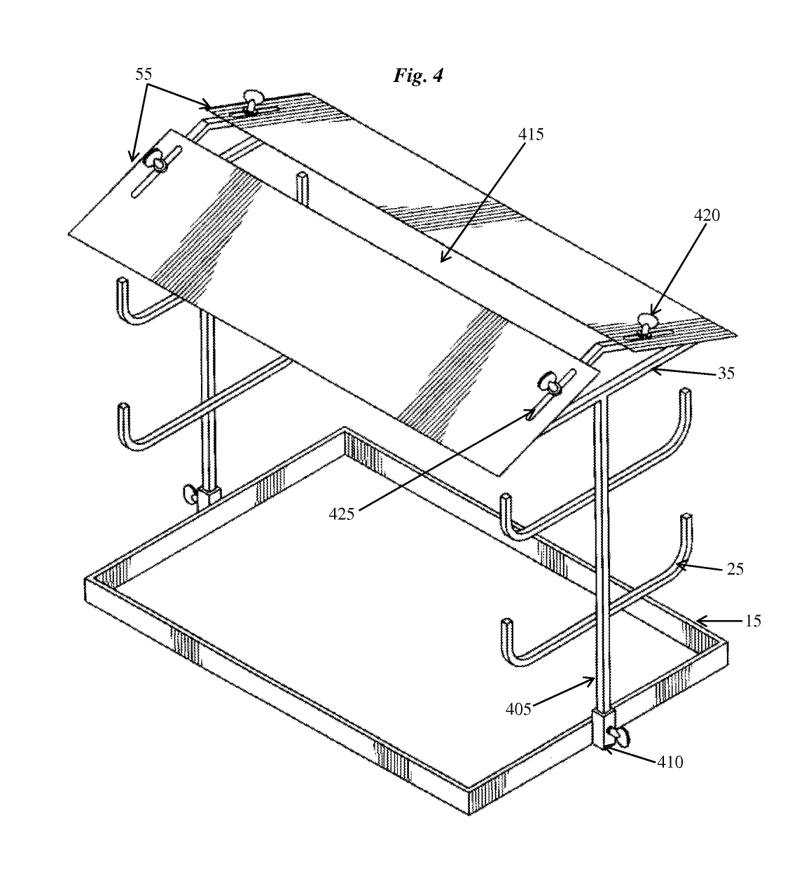

FIG. 4 is an assembled view of the grilling device with vertical skewer supports 405 extending from the base frame 15. As can be seen, the proximal ends of the vertical skewer supports 405 are connected to the base frame 15 via base frame bores 410 situated outside the perimeter of the base frame 15 on opposite sides. The vertical skewer supports 405 are attached to skewer supports 25. The distal ends of the vertical skewer supports 405 are connected to the top plate 55. In some embodiments, wherein the top plate 55 comprises a single heat plate 50, the connection is directly to the top plate. In other embodiments, wherein the top plate comprises a plurality of heat plates, the connection is via a heat plate rack 35 as exemplified in FIG. 4. Additionally, in this embodiment and others, the heat plates 50 can be moved away from the juncture 415 or toward the juncture 415 in order to regulate the amount of heat radiated or reflected from the heat plates 50. In this illustration, heat plate screws 420 tighten the heat plates 50 to the heat plate rack 35. As can be further seen, oblong slots 425 are used in conjunction with the heat plate screws 420 to space the juncture 415 correctly for heat dissipation or retention.

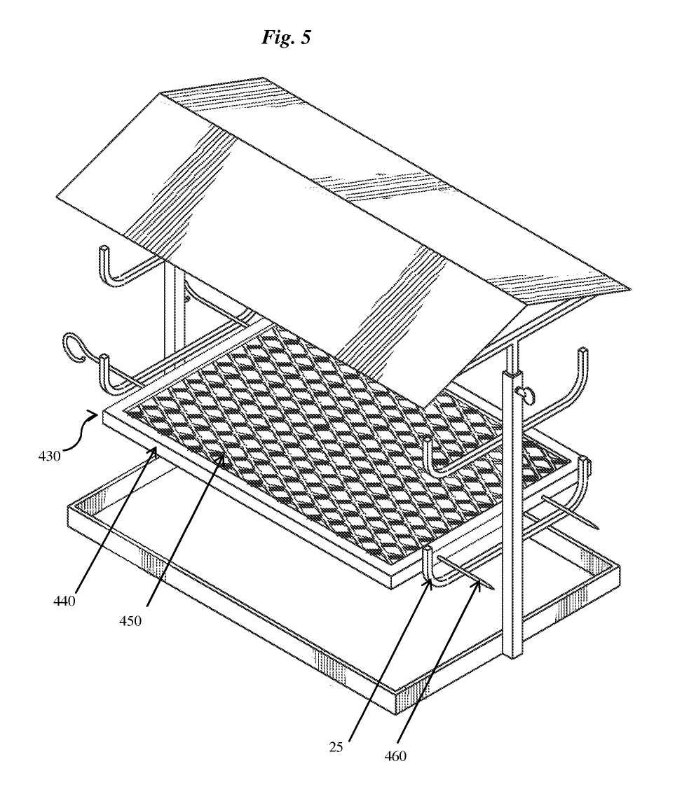

As seen in FIG. 5, the elevated grilling surface 430, comprises a elevated grilling surface frame 440 which is proximal to the skewer supports 25. Within the elevated grilling surface frame is cooking plane 450. As can be further seen, the elevated grilling surface frame rests on skewers 460 which themselves rest on the skewer supports 25.

1. A device for distributing heat in more than one direction to cook food products, the device comprising:
a. a rectangular base frame defining two sides opposite perpendicular to two other sides positioned on a grilling surface, the base frame having a perimeter, the area within the perimeter substantially open to allow heat to travel in a distal direction;
b. two or more vertical supports positioned on opposite sides of the base frame with proximal ends connected to the base frame and distal ends connected to a top plate, each vertical support having a vertical support axis;
c. a plurality of skewer supports attached to the vertical supports and defining a first plane, the first plane being a defined distance from the base frame, the plurality of skewer supports positioned in a parallel direction with respect to the sides of the base frame with vertical supports;
d. a top plate with a proximal side connected to the vertical supports, the top plate being able to reflect heat emitted from the grilling surface or radiate heat; and
e. a plurality of skewers for holding food within the device, each skewer being positioned and held in place by a skewer support of one vertical support and a skewer support of another vertical support.

2. The device of claim 1, further comprising a plurality of skewer supports defining a second plane, the second plane being positioned distally from the base frame than the defined distance.

3. The device of claim 1, wherein the top plate reflects heat from the grilling surface.

4. The device of claim 1, wherein the top plate radiates heat.

5. The device of claim 1, wherein the top plate is comprised of multiple heat plates.

6. The device of claim 5, wherein each heat plate is in physical connection with each other heat plate at a juncture.

7. The device of claim 6, wherein the juncture is at a distal most position on the device from the grilling surface.

8. The device of claim 5, wherein two or more heat plates are not in physical connection with each other at a juncture, the juncture having a distance between the two or more heat plates.

9. The device of claim 8, wherein the juncture is at a distal most position on the device from the grilling surface.

10. The device of claim 8, wherein the distance of the juncture is capable of being increased or decreased.

11. The device of claim 1, wherein each vertical support comprises a proximal vertical support and a distal vertical support, the distal vertical support being movable in a proximal or distal direction relative to the proximal distal support.

12. The device of claim 11, wherein distal vertical support further comprises a threaded bore perpendicular to the vertical support axis and adapted to receive a threaded screw or bolt so as to secure the proximal distal support to the distal vertical support.

13. The device of claim 11, wherein the proximal vertical support further comprises a threaded bore perpendicular to the vertical support axis and adapted to receive a threaded screw or bolt so as to secure the proximal distal support to the distal vertical support.

14. The device of claim 1, further comprising a method of directing heat from the base frame to food.

15. The device of claim 14, wherein the base frame further comprises a plurality or rotatable slats, wherein each rotatable slat is connected to the base frame at two points on opposite sides of the base frame, the rotatable slats capable of being positioned to deflect or redirect heat from the grilling surface.

16. The device of claim 2, further comprising a distal grilling surface parallel to the grilling surface and supported by skewers, the parallel grilling surface capable of being moved in a proximal or distal direction by movement of the skewers from the skewer supports in the first plane to the skewer supports in the second plane.

17. A device for distributing heat in more than one direction to cook food products, the device comprising:
a. an oval or circular base frame positioned on a grilling surface, the base frame having a perimeter, the area within the perimeter substantially open to allow heat to travel in a distal direction, the area at the center of the perimeter having a central vertical support;
b. two or more vertical skewer supports with proximal ends connected to the base frame and rising distally from the base frame;
c. a plurality of skewer supports attached to the vertical skewer supports and attached to the central vertical support, the skewer supports defining a first plane, the first plane being a defined distance from the base frame;
d. an oval or circular top plate with a proximal side connected to the central vertical support, the top plate being able to reflect heat emitted from the grilling surface or radiate heat; and
e. a plurality of skewers for holding food within the device, each skewer being positioned and held in place by a skewer support of one vertical skewer support and a skewer support of the central vertical support.

18. The device of claim 17, further comprising a single top plate shaft, extending proximally from the top plate and adapted to be received by the central vertical support.

19. The device of claim 18, wherein the central vertical support further comprises a threaded bore adapted to receive a central threaded screw, the tightening of the screw preventing sliding of the top plate shaft within the central vertical support.

20. The device of claim 19, wherein the top plate is adjustable in a proximal or distal direction relative to the oval or circular base frame.
